(19) United States
(12) Patent Application Publication
(10) Pub. No.: US 2018/0006729 A1
(43) Pub. Date: Jan. 4, 2018

(54) PROCESS OF ASSEMBLING COHERENT OPTICAL RECEIVER

(71) Applicant: SUMITOMO ELECTRIC DEVICE INNOVATIONS, INC., Yokohama (JP)

(72) Inventors: Ken Ashizawa, Yokohama (JP); Kakushi Nakagawa, Yokohama (JP)

(21) Appl. No.: 15/637,733

(22) Filed: Jun. 29, 2017

(30) Foreign Application Priority Data
Jun. 30, 2016 (JP) 2016-130446
Apr. 4, 2017 (JP) 2017-074560

(51) Int. Cl. H04B 10/61; H04B 10/077

(52) U.S. Cl. CPC H04B 10/614; H04B 10/0779

(57) ABSTRACT

Methods of assembling and testing an optical coherent receiver are disclosed. The method includes steps of, preparing a test beam by combining a first test beam and a second test beam each having respective polarizations orthogonal to each other, entering the test beam accompanied with a third test beam, and aligning a polarization beam splitter (PBS) that splits the test beam depending on the polarizations thereof and a beam splitter (BS) that split the third test beam. A feature of the methods are that the alignment of the PBS and the BS and the monitor of outputs therefrom are concurrently carrier out for two multi-mode interference (MMI) devices.

### CROSS REFERENCE TO RELATED APPLICATIONS

The present application claims the benefit of priority of Japanese Patent Application No. 2016-130446, filed on Jun. 30, 2016, and 2017-074560, filed on Apr. 4, 2017, which are incorporated herein by reference.

### BACKGROUND OF THE INVENTION

### 1. Field of the Invention

The present invention relates to a process of assembling a coherent optical receiver, in particular, the invention relates to a method of testing the coherent optical receiver.

### 2. Background

A Japanese Patent laid open No. JP-H05-158096A has disclosed a coherent optical receiver. An optical receiver to be implemented within the coherent system, which receives an optical signal that multiplexes phases and/or polarizations through a polarization maintaining fiber (PMF), provides a polarization beam splitter (PBS) for splitting the input signal depending on the polarizations and optical hybrids that interfere an optical signal split by the PBS with a local beam. Thus, such an optical coherent receiver may concurrently recover four data from the optical signal depending on the polarizations and the phases.

FIG. 16 schematically shows a functional block diagram of an optical coherent receiver 200 that includes a polarization beam splitter (PBS) 202, a beam splitter (BS) 204, a monitor photodiode (mPD) 206, two multi-mode interference (MMI) devices, 211 and 212, which often called as an optical hybrid, four pairs of photodiodes (PDs) 234, four amplifiers 235, and four pairs of coupling capacitors 236. The optical coherent receiver 200 receives a signal beam N₀ that contains two polarizations orthogonal to each other, and a local beam L₀. The mPD 206 may sense optical power, average power, of a portion of the signal beam N₀ split by the BS 208. The rest of the signal beam N₀ enters the PBS 201 passing the attenuator (ATT) 210, and split thereby depending on the polarizations into two beams, N₁ and N₂. One of the split beams N₁ enters the MMI device 211, while, the other of the split beams N₂ enters the other MMI device 212.

The local beam L₀ is also split into two beams, L₁ and L₂, by the BS 204, one of which L₁ enters the second MMI device 211 and the other L₂ enters the other MMI device 212. The MMI devices, 211 and 212, interfere the signal beams, N₁ and N₂, with the local beams, L₂ and L₁, to extract the signals corresponding to XI and XQ, and to YI to YQ, respectively, where the symbols, X and Y, correspond to the polarizations, while, the symbols, I ad Q, correspond to the phases. That is, the signal XI is recovered from the former signal beam N₁ with the in-phase component with respect to the local beam L₂ by the first MMI device 211, the symbol XQ means that the signal contained in the signal beam N₁ with the quadrature phase against the local beam L₂. Similarly, the symbol YI means that the signal contained in the signal beam N₂ with the in-phase component against the local beam L₁, and the symbol YQ means the signal also contained in the signal beam N₂ with the quadrature phase component against the local beam L₁. Four pairs of the PDs 234 may generate the current signals each corresponding to the signals, XI, XQ, YI, and YQ, in the differential arrangement. Finally, the amplifiers 235 may convert those current signals into respective voltage signals with the differential mode and output those differential voltage signals through the coupling capacitors 236.

As FIG. 16 illustrates, the signal beams, N₀ to N₂, and the local beams, L₀ to L₂, enter the MMI devices, 211 and 212, as passing various optical components, such as lenses for concentrating the signal and local beams when the MMI devices, 211 and 212, in the optical input ports thereof have limited dimensions, or reflectors for bending the optical axes of the beams. In a process of producing the coherent optical receiver 200, such optical components are necessary to be optically aligned with the MMI devices, 211 and 212, in particular, a test beam that emulates the signal beam N₀ is necessary to be externally provided and the optical components are aligned so as to enhance the optical coupling of the test beam with the input ports of the MMI devices, 211 and 212.

In an assembly of an optical coherent receiver applicable to the dual polarizations, two MMI devices, 211 and 212, are necessary to evenly couple with the signal beam. That is, when the signal beam has the only one polarization whose direction makes a substantial angle against the axis of the PBS 202, the PBS 202 may split the signal beam into two beams that couple with the MMI devices, 211 and 212, by respective coupling efficiencies, which are assumed to be A and B. Then, the polarization of the signal beam is rotated by just 90°, that is, the polarizations of the signal beam in the respective sequences are just orthogonal to each other; the PBS 202 also splits the signal beam into two beams that couple with the MMI devices, 211 and 212, by respective coupling efficiencies of B and A. That is, the optical coupling system from the BS 208 to the MMI devices, 211 and 212, is necessary to have the coupling efficiencies for the two polarizations equal to each other. The present invention may provide a technique of assembling the optical components such that the coupling efficiencies for the MMI devices, 211 and 212, even for the respective polarizations.

### SUMMARY OF THE INVENTION

One aspect of the present application relates to a method of assembling an optical coherent receiver that receives a signal beam having two polarizations substantially orthogonal to each other and a local beam having a substantially linear polarization. The optical coherent receiver includes a polarization beam splitter (PBS), a beam splitter (BS), and two multi-mode interference (MMI) devices. The PBS splits the signal beam into two portions depending on the polarizations thereof. The BS splits the local beam into two portions independent of the linear polarization of the local beam. The method comprises steps of: (1) preparing a test beam by combining a first test beam having a substantially linear polarization and a second test beam having a substantially linear polarization whose direction is orthogonal to the polarization of the first test beam, (2) preparing a third test beam having a substantially linear polarization, where the test beam emulates the signal beam, while, the third test beam emulates the local beam, (3) entering the test beam and the third test beam into the coherent receiver from respective dummy ports, and (4) coupling the test beam and the third test beam concurrently with the two MMI devices.

Another aspect of the present application relates to a method of testing the optical coherent receiver. The method includes steps of: (1) generating a first test beam by a first optical source, a second test beam by a second optical source, and a third test beam by a third optical source, (2) adjusting the first test beam and the second test beam such that polarizations thereof become orthogonal to each other; (3) combining the first test beam with the second test beam to generate a combined test beam after adjusting the polarizations thereof; and (4) entering the combined test beam into the optical coherent receiver from one port and the third test beam into the optical coherent receiver from another port.

### DESCRIPTION OF THE DRAWINGS

The accompanying drawings, which are incorporated in and constitute a part of this specification, illustrate one or more implementations described herein and, together with the description, explain these implementations. In the drawings:

FIG. 1 is a plan view showing an inside of an optical coherent receiver according to embodiment of the present invention;

FIG. 2 is a perspective view showing the inside of the optical coherent receiver shown in FIG. 1;

FIGS. 3A to 3C show processes of assembling the optical coherent receiver, where FIG. 3A shows a process of mounting a carrier and multimode interference (MMI device) on a base, FIG. 3B shows a process of further mounting circuit boards, and FIG. 3C shows a process of installing thus assembled components within the housing of the optical coherent receiver;

FIG. 4A schematically explain a process for aligning an auto-collimator, and FIG. 4B show positional relations of a test beam and the housing of the optical coherent receiver;

FIG. 5A shows a process of mounting optical components of the first group on the carrier, and FIG. 5B shows a process for setting dummy ports against the housing;

FIG. 6 shows a manipulator that secures the dummy port against the housing;

FIGS. 7A schematically shows a functional block diagram for preparing a test beam with two polarizations, and 7B schematically shows functional block diagram for providing the test beam in the housing through the dummy port;

FIG. 8 schematically shows a block diagram for preparing the test beam modified from that shown in FIG. 7A;

FIG. 9 explains a mechanism of combining two optical beams each having polarizations orthogonal to each other;

FIG. 10 shows a process of mounting optical components of the second group on the carrier;

FIG. 11A shows a process of mounting first lenses positioned closer to the MMI devices in the respective lens units, and FIG. 11B shows a process of mounting second lenses positioned apart from the MMI devices;

FIG. 12A shows a process of mounting an input lens and a variable optical attenuator VOA, and FIG. 12B shows a process of mounting optical attenuators on the carrier;

FIG. 13 shows a manipulator that secures the VOA as providing a bias with a low frequency for adjusting the attenuation of the VOA;

FIG. 14A is a perspective view showing a process of air-tightly sealing the housing by the lid, and FIG. 14B is a perspective view showing a process of replacing the dummy ports with the signal port and the local port, and fixing them to the housing;

FIG. 15 schematically shows a setup for monitoring the outputs of the optical coherent receiver during the process for installing the optical components; and

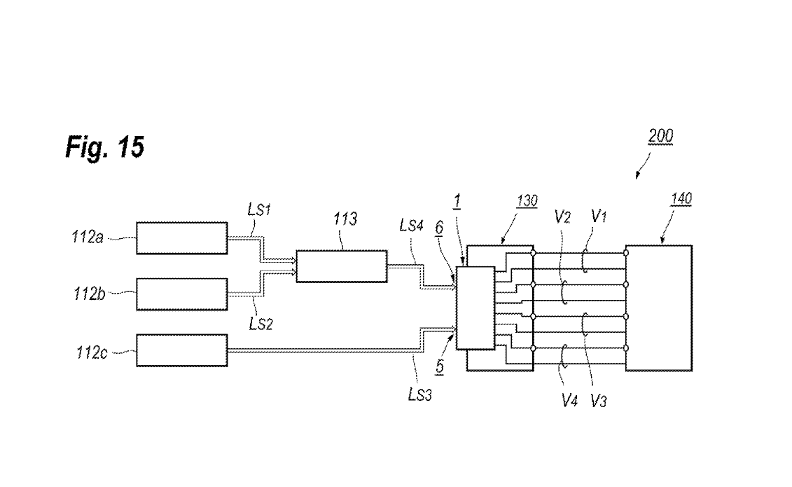

FIG. 16 schematically shows a functional block diagram of an optical coherent receiver with the function of a dual polarization quadrature phase shift keying (DPQPSK).

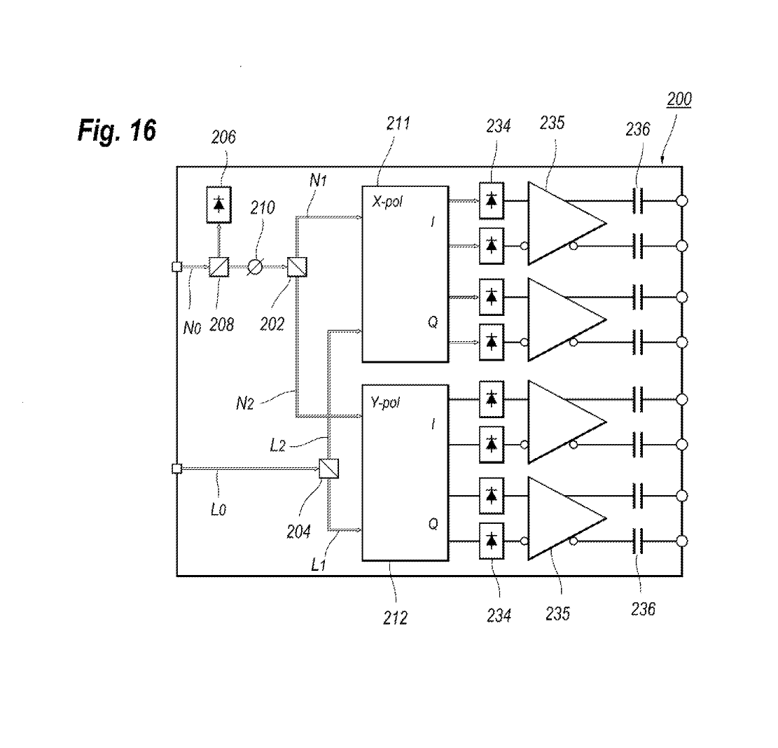

### DESCRIPTION OF EMBODIMENT

Next, embodiment according to the present invention will be described as referring to accompany drawings. In the description of the drawings, numerals or symbols same with or similar to each other will refer to element same with or similar to each other without duplicating explanations. The present invention is not restricted in the embodiment described below, and encompasses those defined in claims, all modifications thereof and all equivalents thereto.

### First Embodiment

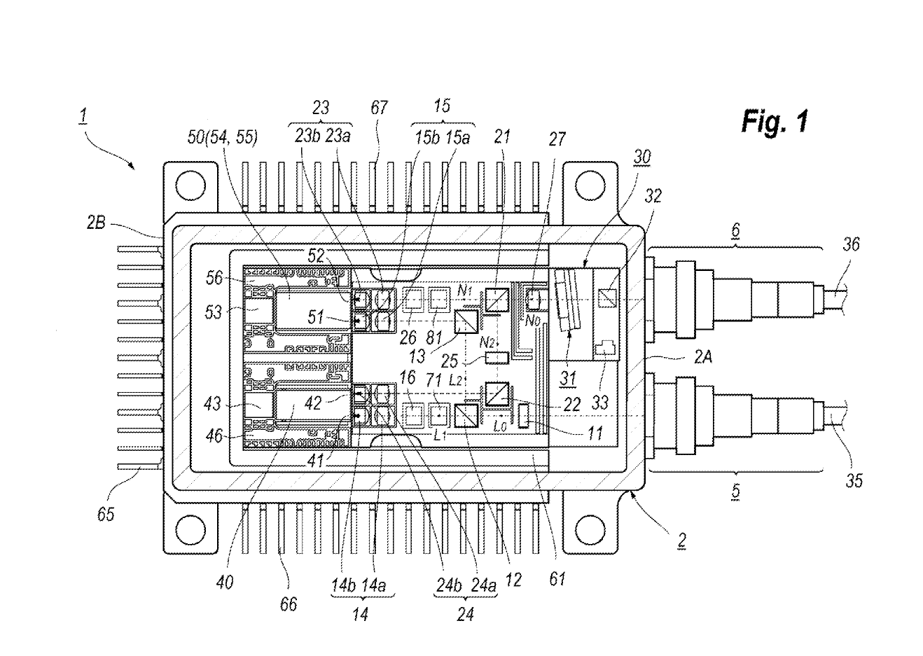

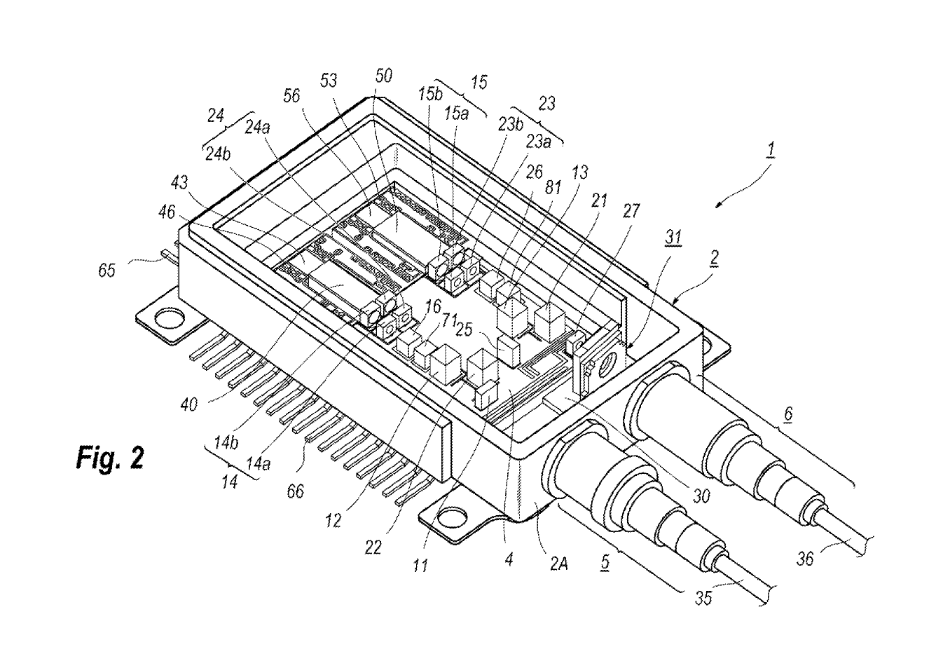

FIG. 1 is a plan view schematically showing an optical coherent receiver according to an embodiment of the present invention, and FIG. 2 is a perspective view showing an inside of the optical coherent receiver shown in FIG. 1. The optical coherent receiver 1 may recover data involved in a signal beam (Sig) modulated in phases thereof by interfering the signal beam with a local beam (Lo). The recovered data are externally output after converting into electrical signals. The optical coherent receiver 1 includes optical systems each provided for the signal beam Sig and the local beam Lo independently, and two multi-mode interferences (MMI) devices, 40 and 50, which are sometimes called as optical hybrids, within a housing 2. The optical systems, and two MMI devices, 40 and 50, are mounted on a bottom 2E of the housing 2 through a carrier 4 that is made of electrically insulating material such as alumina (Al₂O₃) or aluminum nitride (AlN). Provided on the bottom 2E of the housing 2 is circuit boards, 46 and 56, that mount circuits for processing the recovered data. Two MMI devices, 40 and 50, are primarily made of semiconductor material typically indium phosphide (InP). The first MMI device 40, which provides input ports, 41 and 42, for the local beam and the signal beam, respectively, may recover the data contained in the signal beam by interfering the signal beam input to the input port 42 for the signal beam and the local beam input to the input port 41 for the local beam Lo. Similarly, the second MMI device 50, which also provides input ports for the local beam 51 and for the signal beam 52, may recover data contained in the signal beam Sig by interfering two beams of the signal beam input to the input port 52 and the local beam input to the input port 51. The present embodiment of the optical coherent receiver 1 provides two MMI devices independently; however, an optical coherent receiver may integrate two MMI devices.

The housing 2 also provides a front wall 2A. The description below assumes that the direction of “front” and/or “forward” corresponds to a side where the front wall 2A provides, while the other direction of “rear” and/or “back” opposite thereto. However, these directions are only for an explanation and never restrict the scope of the present invention. The front wall 2A provides a coupling unit 5 for the local beam Lo and a coupling unit 6 for the signal beam Sig fixed by, for instance, the laser welding. The local beam Lo enters through the coupling unit 5 from a polarization maintaining fiber (PMF) 35, while, the signal beam N₀ enters through the coupling unit 6 from a single mode fiber (SMF) 36. The local beam Lo and the signal beam N₀, which have divergent beam shapes, are converted into respective collimated beams by lenses installed within the respective coupling units, 5 and 6, then enter within the housing 2.

The optical system for the local beam Lo couples the local beam provided from the local coupling unit 5 evenly with the input ports, 41 and 51, in the MMI devices, 40 and 50. Specifically, the optical system for the local beam Lo includes a polarizer 11, a beam splitter (BS) 12, a reflector 13, two lens units, 14 and 15, a skew adjustor 16, and an attenuator 71. The skew adjustor 16 and/or the attenuator 51 may be optionally omitted.

The polarizer 11, which optically couples with the local coupling unit 5, aligns the polarization direction of the local beam Lo provided from the coupling unit 5. An optical source for the local beam Lo may generate an optical beam with elliptical polarization whose major axis is considerably longer than a minor axis. Also, even when the optical source may generate a beam with the linear polarization, the polarization direction of the local beam Lo provided from the local coupling unit 5 is not always aligned with the designed direction because of positional accuracy of optical parts set on the optical path from the source to the optical coherent receiver 1. The polarizer 11 may rearrange the polarization direction of the local beam Lo provided from the coupling unit 5 with the desired direction, which may be a direction parallel to the bottom 2E.

The BS12 may evenly split the local beam Lo provided from the polarizer 11 with a ratio of 50:50. One of the split beam L₁ advances toward the MMI device 40. The other of the split beam L₂, which is reflected by the BS 11, advances toward the other MMI device 50 reflected by the reflector 13. The BS12 and the reflector 13 illustrated in FIGS. 1 and 2 have a type of the prism, where two prisms are attached to each other and an attached face shows a function of splitting and reflecting a beam. However, the optical coherent receiver 1 may provide another type of the BS 12 and the reflector 13, that is, a BS and/or a reflector with a type of a slab whose one surface provides a multi-layered optical film for showing a function of splitting and/or reflecting an optical beam.

The lens unit 14, which is disposed on the optical axis connecting the BS 12 with the MMI device 40, concentrates the optical beam L₁ split by the BS 11 onto the input port 41 for the local beam in the MMI device 40. The lens unit 15 concentrates the other optical beam L₂ split by the BS 11 onto the input port 51 for the local beam in the MMI device 50. The lens units, 14 and 15, provide first lenses, 14b and 15b, positioned closer to the MMI devices, 40 and 50, and second lenses, 14a and 15a, positioned apart from the MMI devices, 40 and 50, that is, the first lenses, 14b and 15b, are positioned between the second lenses, 14a and 15a, and the MMI devices, 40 and 50, respectively. Those two lens system may enhance the optical coupling efficiency for the input ports, 41 and 51, of the local beams, L₁ and L₂, in spite of a restricted window of the input ports, 41 and 51.

The skew adjustors 16, which is disposed on the optical axis connecting the BS 12 with the lens unit 14, may compensate a difference in optical lengths of the split beams, L₁ and L₂. That is, the latter beam L₂ in the optical path thereof is longer than the optical path of the former beam L₁ by a length from the BS 12 to the reflector 13. The skew adjustor 16 may compensate this optical path difference. The skew adjustor 16 may be made of silicon (Si), and have transmittance for the optical beams, L₁ and L₂, to be around 99%, which means that the skew adjust 16 becomes substantially transparent for the local beam Lo

The optical system for the signal beam Sig includes a polarization beam splitter (PBS) 21, a reflector 22, two lens units, 23 and 24, a half wavelength (λ/2) plate 25, a skew adjustor 26, and an attenuator 81. The skew adjustor 26 and/or the attenuator 81 are optional, and may be omitted from the optical coherent receiver 1.

The PBS 21, which optically couples with the signal coupling unit 6, may evenly split the signal beam N₀ provided from the SMF 36 through the signal coupling unit 6 depending on polarizations thereof. Specifically, the PBS 21 advances or transmits a signal beam N₁ with the polarization parallel to the bottom 2E, while reflects another signal beam N₂ with the polarization perpendicular to the bottom 2E.

The signal beam N₁ transmitting through the PBS 21 couples with the input port 52 for the signal beam of the MMI device 50 after passing the attenuator 81, the skew adjustor 26, and the lens unit 23. The skew adjustor 26, which is disposed on the optical path from the PBS 21 to the lens unit 23, may compensate the optical path difference from the PBS 21 to the signal ports, 42 and 52, of the MMI devices, 40 and 50, between the signal beams, N₁ and N₂, that are split by the PBS 21. That is, the optical path length for the signal beam N₂ is longer than the other optical path length for the signal beam N₁ by the path length from the PBS 21 to the reflector 22. The skew adjustor 26 may compensate this optical path difference, in other words, a time difference to the input ports, 42 and 52, for the signal beams, N₁ and N₂, of the MMI devices, 40 and 50. The skew adjustor 26 may be made of material same with that of the other skew adjustor 16.

The λ/2 plate 25 may rotate the polarization of the other signal beam N₂, which is reflected by the PBS 21, by a right angle, 90°. Two signal beams, N₁ and N₂, in the polarizations thereof are perpendicular to each other immediately output from the PBS 21. Passing the signal beam N₂ through the λ/2 plate 25, which rotates the polarization by 90° as described above, two signal beams, N₁ and N₂, in the polarizations thereof become aligned to each other. The signal beam N₂ thus rotated in the polarization thereof is reflected by the reflector 22 and couples with the input port 42 for the signal beam of the MMI device 40 through the lens unit 24. The PBS 21 and the reflector 22 shown in FIGS. 1 and 2, have an arrangement of attaching two prisms with an interface showing functions of the light splitting surface and the light reflecting surface. However, the PBS 21 and the reflector 22 are not restricted to those arrangements. A slab type arrangement, where a slab made of material transparent to the signal beams, N₁ and n2, with functions of the light splitting and the light reflecting in a face of the slab, may be applicable as the PBS 21 and the reflector 22.

The lens unit 21, which is disposed on the optical path from the PBS 21 to the second MMI device, 50 may concentrate the signal beam N₁ that is split by the PBS21 onto the input port 52 for the signal beam in the second MMI device 50. The lens unit 24, which is disposed on the optical path from the reflector 22 to the first MMI device 40, may concentrate the other signal beam N₂ split by the PBS 21 and reflected by the reflector 22 onto the input port 42 for the signal beam in the first MMI device 40. These lens units, 23 and 24, include first lenses, 23b and 24b, disposed closer to the MMI devices, 40 and 50; and second lenses, 23a and 24a, disposed apart from the MMI devices, 40 and 50. The lens unit, 23 and 24, each combining the first lenses, 23b and 24b, with the second lenses, 23a and 24a, may enhance the coupling efficiencies of the signal beams, N₁ and N₂, with the input ports, 42 and 52, for the signal beam.

The first MMI device 40 includes MMI waveguides and photodiodes (PDs) optically coupled with the MMI waveguides. The MMI waveguides, which may be formed on a semiconductor substrate made of indium phosphide (InP), interferes the signal beam N₂ input to the input port 42 for the signal beam with the local beam N₁ input to the input port 41 for the local beam to extract data contained in the signal beam N₁ having a phase aligned with the phase of the local beam N₂, and another data also contained in the signal beam N₁ but having a phase shifted by 90° from the phase of the local beam N₂. Similarly, the second MMI device 50, which includes MMI waveguides formed on the InP substrate and photodiodes (PDs) coupled with the MMI waveguides, interferes the signal beam N₁ input to the input port 52 for the signal beam with the local beam L₂ input to the input port 51 for the local beam to extract two data independent to each other.

The housing 2 includes the front wall 2A and a rear wall 2B in a side opposite to the front wall 2A, that is, the front wall 2A faces the rear wall 2B. The housing 2 also provides feed throughs 61 arranged in the rear wall and the respective sides connecting the front wall 2A with the rear wall 2B, that is, the side walls except for the front wall 2A provide the feedthroughs 61, where a part of the feedthroughs 61 provided in the rear wall 2B have terminals 65 thereon to provide the four data extracted from the signal beams, N₁ and N₂, outside of the housing 2 after being processed by the ICs, 43 and 53. Rest of the feedthroughs in the respective sides provides terminals 66 and 67, for providing biases to the MMI devices, 40 and 50, and extracting statuses of the devices in the housing 2, where those biases and statuses are DC signals or low frequency (LF) signals. The ICs, 43 and 53, are mounted on respective substrates, 46 and 56, with a plane shape of the U-character. The substrates, 46 and 56, may further mount resistors and capacitors, and DC/DC converters if necessary.

When the coupling efficiency of the local beam L₁ with the first MMI device 40 is greater than the coupling efficiency of the signal beam N₂ with the first MMI device 40, the optical coherent receiver 1 may further install an attenuator 71 on the optical pass for the local beam L₁. Similarly, when the coupling efficiency for the signal beam N₁ with the second MMI device 50 is greater than the coupling efficiency for the local beam L₂, the optical coherent receiver 1 may install another attenuator 81 on the optical pass for the signal beam N₁. Thus, those attenuators, 71 and 81, may equalize the coupling efficiencies of the local beams, L₁ and L₂, with the MMI devices, 40 and 50, to the coupling efficiencies of the signal beams, N₁ and N₂, with the MMI devices, 40 and 50, which may enhance the accuracy of the recovery of the data in the MMI devices, 40 and 50.

The optical coherent receiver 1 may further provide a variable optical attenuator (VOA) 31, a BS 32, and a monitor PD (mPD) 33 on the optical path for the signal beam N₀ from the PBS 21 to the signal coupling unit 6. The BS 32 may split the signal beam N₀ input to the signal coupling unit 6 into two portions, one of which enters the mPD 33 that generates a status signal proportional to the average magnitude of the signal beam N₀.

The VOA 31 may attenuate the signal beam N₀ passing the BS 32. The attenuation in the VOA 31 may be varied by a control signal input into the optical coherent receiver 1. For instance, when the optical coherent receiver 1 is under a condition of receiving excess power sensed through the status signal from the mPD 33, the control signal increases the attenuation of the VOA 31 to reduce the magnitude of the signal beams, N₁ and N₂, entering the MMI devices, 40 and 50. The input lens 27 may collimate the signal beam N₀ provided from the VOA 31, which may enhance the coupling efficiencies of the signal beams, N and N₂, with the MMI devices, 40 and 50, even the optical paths from the input lens 27 to the MMI devices, 40 and 50, are extended. The VOA 31 is preferably positioned at a beam waist of the signal beam N₀ formed between the signal coupling unit 6 and the input lens 27 by a lens set within the signal coupling unit 6, which secures the attenuation efficiency of the VOA 31. The BS 32, the VOA 31, and the mPD 33 are mounted on the bottom 2E of the housing 2 with interposing a VOA carrier 30 therebetween, where the VOA carrier provides a step on a top surface thereof with an upper step that mounts the BS 32 and the mPD 33, while a lower step that mounts the VOA 31.

Next, a process of assembling the optical coherent receiver 1 according to the present invention will be described.

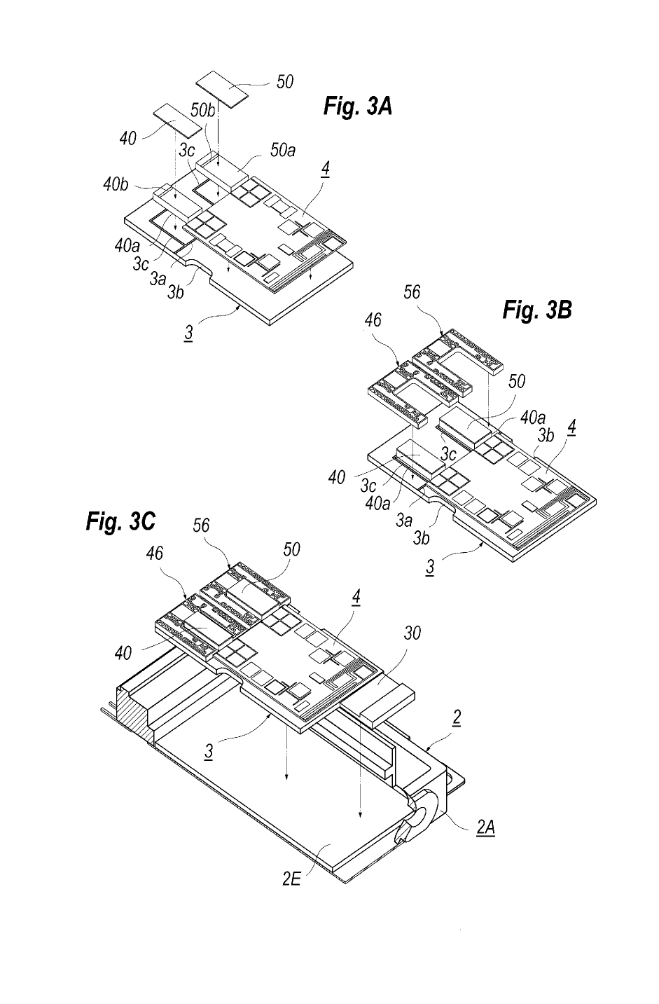

First, as shown in FIG. 3A, a carrier 4 is mounted on a base 3 in an outside of the housing 2. The base 3, which may be made of, for instance, copper tungsten (CuW), has a rectangular slab. The carrier 4 may be made of, for instance, aluminum oxide (Al₂O₃), has also a rectangular slab. Eutectic solder such as gold tin (AuSn) may fix the carrier 4 on the base 3. The base 3 in a top thereof provides a groove 3a that partitions the top of the base 3 into an area for mounting the carrier 4 and another area for mounting the MMI devices, 40 and 50. Aligning the carrier 4 in a rear edge thereof with a front edge of the groove 3a only through a visual inspection, a position of the carrier 4 relative to the base 3 may be determined. In an alternative, the carrier 4 may be set on the base 3 by aligning the front edge thereof with the front edge of the base 3.

Because the base 3 has a width nearly equal to or slightly narrower than an inner width of the housing 2, which makes hard to install the base 3 within the housing 2, the base 3 preferably provides a pinched side 3b with a width thereof narrower than that of rest portions. The installation of the base 3 within the housing 2 may be facilitated by picking the pinched side 3b of the base 3. The carrier 4 in a lateral direction thereof may be aligned by the width of the pinched side 3b of the base 3.

Next, the process mounts the MMI devices, 40 and 50, on the respective MMI carriers, 40a and 50a. The MMI carriers, 40a and 50a, are rectangular blocks made of ceramics such as aluminum nitride (AlN), aluminum oxide (Al₂O₃), and so on. The MMI devices, 40 and 50, are fixed on the MMI carriers, 40a and 50a, with eutectic alloy of gold tin (AuSn), which is a conventional technique in assembling a semiconductor device on an insulating substrate. Then, the MMI carriers, 40a and 50a, with the MMI devices, 40 and 50, thereon, are mounted on the base 3 in an area behind the carrier 4. The base 3 provides in the top surface thereof grooves 3c that surround respective areas on which the MMI carriers, 40a and 50a, are placed. The MMI carriers, 40a and 50a, are aligned with those grooves 3c only through the visual inspection.

The MMI carriers, 40a and 50a, also provides in tops thereof grooves, 40b and 50b, laterally extending for demarcating front areas from rear areas. The front areas overlap with portions of the MMI devices, 40 and 50, where waveguides are formed; while, the latter areas overlap with portions of the MMI devices, 40 and 50, where photodiodes (PDs) are formed. The MMI devices, 40 and 50, provide respective back metals, which are similar to a semiconductor device to be die-bonded on an insulating substrate. However, the back metals sometimes cause a leak current in the PDs. The back metals of the MMI devices, 40 and 50, of the present embodiment are physically divided into two areas, one of which corresponds to the front areas of the MMI carriers, 40a and 50a, while, rests of which correspond to the rear areas of the MMI carriers, 40a and 50a. Thus, the MMI devices, 40 and 50, of the embodiment not only electrically but physically isolate the back metals by the grooves, 40b and 50b, which effectively reduces the leak current for the PDs.

Concurrently with the assembly of the MMI devices, 40 and 50, on the MMI carriers, 40a and 50a, the process mounts, also in the outside of the housing 2, die capacitors on respective circuit boards, 46 and 56, which may be made of aluminum nitride (AlN), by soldering or using metal pellet of gold tin (AuSn). Then, as FIG. 3B illustrates, one of the circuit board 46 is fixed on the base 3 so as to surround the MMI device 40, while, the other of the circuit boards 56 is also fixed on the base 3 so as to surround the other MMI device 50.

Then, as shown in FIG. 3C which partially cuts the sides of the housing 2, the base 3, on which the carrier 4, the MMI carriers, 40a and 50a, and the circuit boards, 46 and 56, are mounted, is set on the bottom 2E of the housing 2. Abutting the front edge of the base 3 against the inside of the front wall 2A to align the carrier 4 in a direction perpendicular to the optical axes of the coupling units, 5 and 6, then retreating base 3 backward by a preset amount, the base 3 is installed onto the bottom 2E of the housing 2. As shown in FIGS. 1 and 2, the interiors of the sides provide steps and overhangs, where upper portions thereof are made of metal, while, lower portions thereof are made of ceramics to electrically isolate the terminals, 65 to 67. An inner width between the lower portions is substantially equal to the width of the base 3, while, that between the upper portions is wider than the width of the base 3. Accordingly, the base 3 in the front edge thereof may abut against the upper portion of the front wall 2A. The abutting alignment of the base 3 against the front wall 2A may show accuracy within ±0.5°. The base 3 may be fixed on the bottom 2E by, for instance, soldering.

Subsequent to the installation of the base 3, the process mounts the VOA carrier 30 on the bottom 2E of the housing 2. Abutting an edge of the VOA carrier 30 against the inside of the front wall 2A to align the VOA carrier 30 with the housing 2, and retreating the VOA carrier 30 by a preset amount, the process may mount the VOA carrier 30 on the bottom 2E of the housing 2. Thus, the VOA carrier 30 is aligned with the carrier 4, that is, the front edge of the carrier 4 becomes in parallel to the rear edge of the VOA carrier 30. The VOA carrier 30 is fixed on the bottom 2E of the housing also by soldering.

Then, the process installs the integrated circuits (ICs), 43 and 53, which are shown in FIGS. 1 and 2, and may be amplifiers, on the circuit boards, 46 and 56, by a conventional technique using conductive resin. Exposing an intermediate assembly of the housing 2, the base 3 that mounts the MMI devices, 40 and 50, through the MMI carriers, 40a and 50a, the circuit boards, 46 and 56, that mount the ICs, 43 and 53, in a high temperature around 180° C., solvents containing in the resin may be vaporized. Then, the process performs the wire-boding between the built-in PDs in the MMI devices, 40 and 50, and the ICs, 43 and 53; and between pads provided on the surfaces of the ICs, 43 and 53, and the terminals 65 in the rear of the housing 2. Thus, the built-in PDs in the MMI devices, 40 and 50, become operable and electrical signals generated by the built-in PDs becomes extractable from the optical coherent receiver 1, which enables an active alignment of optical components using the built-in PDs. The active alignment aligns the optical components such that electrical outputs of the built-in PDs are monitored as practically providing test beams to the MMI devices, 40 and 50, through the optical components.

Next, the process prepares a reference block 104 that provides a reference surface 104a precisely aligned with a bottom 104b thereof in a right angle. The reference surface 104a and the bottom 104b emulate the front wall 2A and the back surface of the housing 2, respectively. The reference block 104, which may be a rectangular block made of glass, is set on an alignment stage 103 of the alignment apparatus 105 such that the bottom 104b makes closely contact to the top of the alignment stage 103.

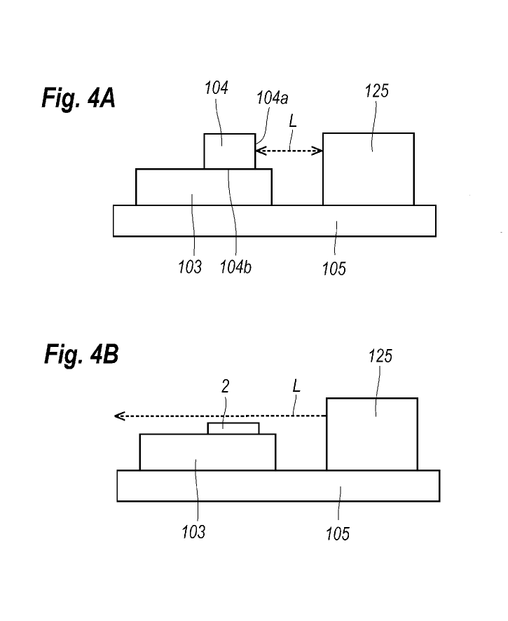

Then, the auto-collimator 125 in the optical axis thereof is aligned with the normal of the reference block 104, as FIG. 4A illustrates. Specifically, the auto-collimator 125 outputs an alignment beam L, and detects a beam reflected by the reference surface 104a. When the auto-collimator 125 detects the reflected beam with maximum power, the optical axis of the alignment beam L fully overlaps with the optical axis of the reflected beam. That is, the alignment stage 103 may adjust the rotation and the tilting of the reference mirror 104 with respect to the auto-collimator 125 so as to maximize the alignment beam reflected by the reference surface 104a.

Then, the process replaces the reference mirror 104 with the housing 2 that mounts the base 3 and the VOA carrier 30 therein, as FIG. 4B illustrates. The back surface of the housing 2 is closely contact to the top surface of the alignment stage 103. Because a height of the housing 2 is less than the optical axis of the alignment beam L, the alignment beam L output from the auto-collimator 125 passes a space above the housing 2; that is, the alignment beam L does not enter the housing 2, as shown in FIG. 4B

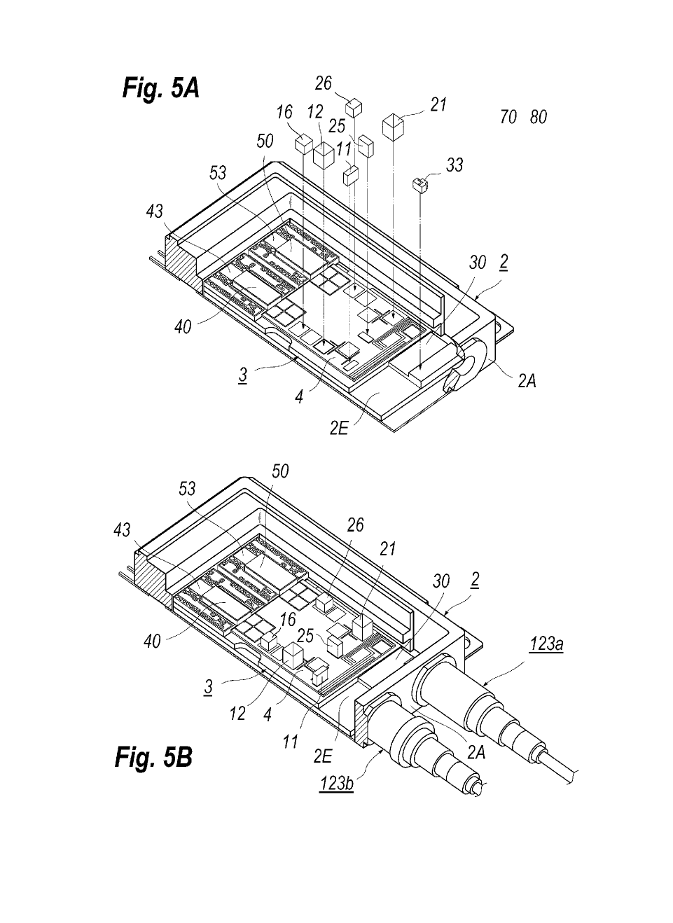

Then, the process optically aligns the optical components. First, as shown in FIG. 5A, the process mounts the monitor photodiode (mPD) 33 on the VOA carrier 30; and the PBS 21, the skew adjustors, 16 and 26, the λ/2 plate 25, the polarizer 11, and the BS 25 on the carrier 4. These optical components are unnecessary to be actively aligned; only angles of the optical axes thereof are necessary to be adjusted.

That is, the process of aligning those optical components uses the auto-collimator 125 shown in FIGS. 4A and 4B to align the angle of the optical axes thereof. Specifically, reflecting the alignment beam L output from the auto-collimator 125 by one side of those optical components and overlapping the alignment beam L reflected by the one side with the alignment beam L entering the one side, the process may align the angle of those optical components. This angle alignment is carried out in the space above the housing 2. Then, moving the components on the carrier 4, or the VOA carrier 30, exactly, on adhesive resin applied in respective positions where the optical components are to be placed, as keeping the angle thereof, or rotating by 90°, and curing the adhesive resin, the optical components may be fixed at the designed positions.

Because the PBS 21, the BS 12, the skew adjustors, 16 and 26, and the polarizer 11, which are hereinafter called as the optical components in the first group, in the beam incoming surfaces thereof face toward the front wall 2A when they are installed within the housing 2; those components are aligned such that the beam incoming surfaces receive the alignment beam L of the auto-collimator 125 and the optical axes of the beam incoming surfaces, namely, the normal of the beam incoming surfaces, coincide with the optical axis of the alignment beam L. After the alignment by the auto-collimator 125, those components are set on the carrier 4 as keeping the angle of the beam incoming surfaces thereof, as shown in FIG. 5A. The λ/2 plate 11 and the mPD 33 have the beam incoming surface thereof perpendicular to the longitudinal axis of the housing 2; accordingly, after the alignment of the beam incoming surfaces by the auto-collimator 125 so as to coincide with the optical axis of the alignment beam L, those components are rotated by 90°, then, placed on the carrier 4. For the mPD 33, an additional process of the wire-boding to the terminal 67 is carried out after the placement on the carrier 4.

The process next installs other optical components except for those described above, which are involved in the second group of the optical components including the input lens 27, the first and second reflectors, 13 and 22, and for lens systems, 14, 15, 23, and 24, where those components have alignment tolerance against the MMI devices, 40 and 50, considerably smaller than those of the aforementioned components, 11, 12, 16, 26, and 33, of the first group. Accordingly, the active alignment with respect to the MMI devices, 40 and 50, becomes inevitable. The process first prepares dummy ports, 123a and 123b, which may emulate the coupling units, 5 and 6, respectively; and provide test beams for aligning the optical components of the second group. Next, the alignment process for the second group of the optical components will be described in detail.

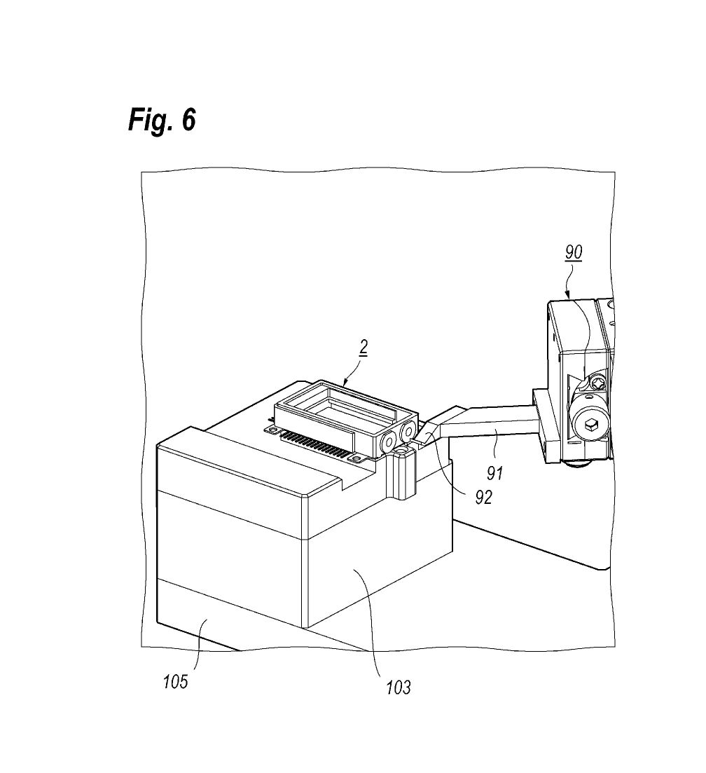

FIG. 6 illustrates a manipulator 90 that holds the dummy port 123a. The manipulator 90 includes an arm 91 and an arm head 92. The arm 91 may adjust attitudes, positions and angles, of the dummy port 123a supported by the arm head 92, specifically, in parallel to, in perpendicular to, and inclination to the optical axis thereof. Although FIG. 6 illustrates only one manipulator 90 for the one of the dump port 123a, another manipulator may hold the other dummy port 123b and align the attitude thereof.

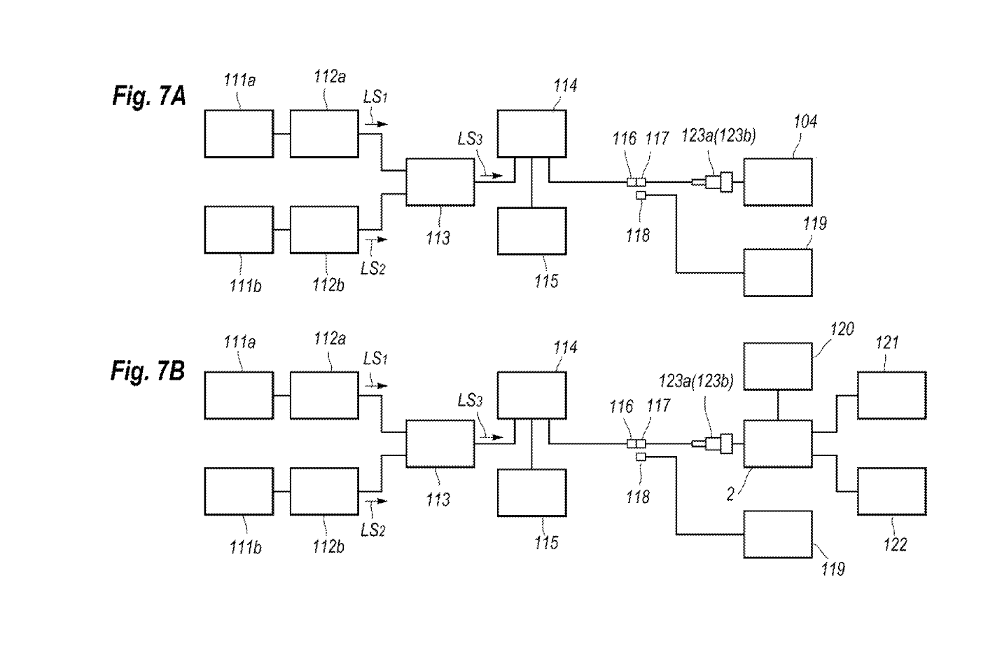

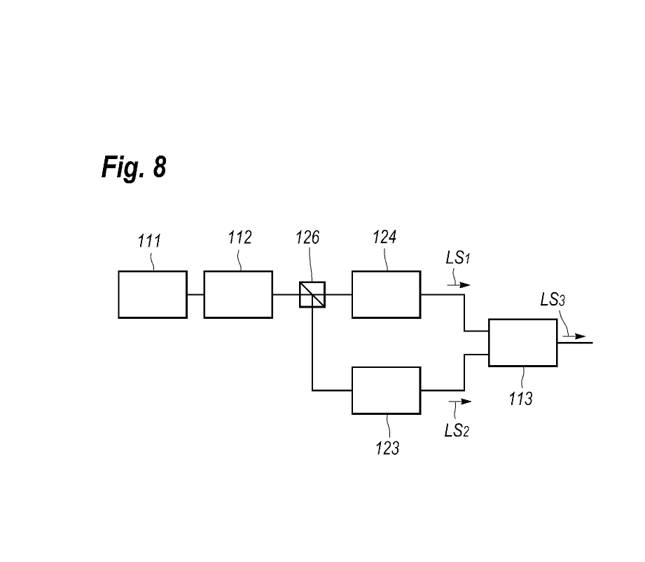

FIG. 7A shows a functional block diagram of a setup for preparing the test beam. The setup includes bias sources, 111a and 111b, that provide biases to optical sources, 112a and 112b, which may be laser diodes (LDs), that generate the test beams, L_{S1} and L_{S2}, and a polarization beam combiner (PBC) 113 that combines the two test beams, L_{S1} and L_{S2}. The test beams, L_{S1} and L_{S2}, are provided in a PBC 113 after the polarizations thereof are adjusted so as to make an angle of 90°. For instance, a λ/2 plate is provided downstream only of the one of the LDs, 112a and 112b. Two test beams, L_{S1} and L_{S2}, may have wavelengths substantially equal to each other, or, wavelengths difference from each other. An alternative is shown in FIG. 8 when two test beams, L_{S1} and L_{S2}, have the wavelengths substantially equal to each other, where the setup provides only one bias source 111 and one LD 112. The output of the LD 112 is split by a BS 126 into two portions, one of which enters a λ/2 plate 123 to be rotated in the polarization thereof by 90°, while the other enters a skew adjustor 124. The outputs, L_{S1} and L_{S2}, of the λ/2 plate 123 and the skew adjustor 124 are combined by the PBC 113. Polarization maintaining fibers may connect the optical sources, 112a and 112b, with the PBC 113.

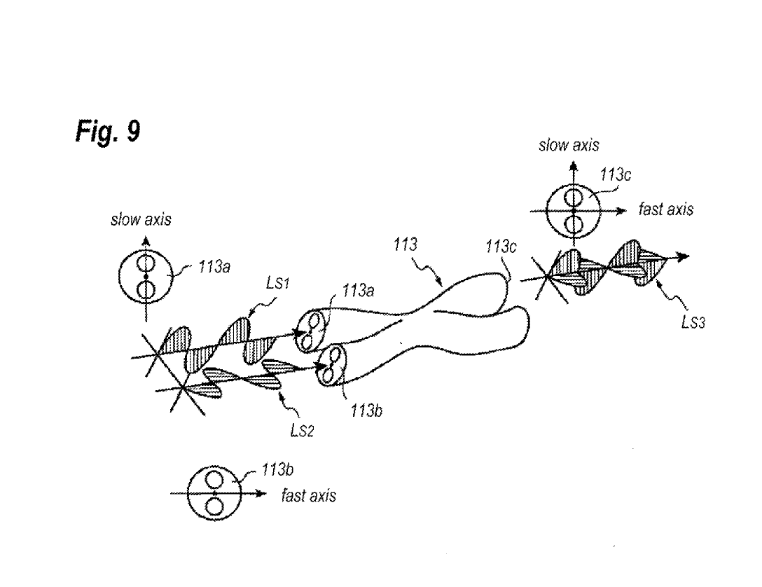

FIG. 9 schematically illustrates an example of the PBC 113. The PBC 113, which has two polarization maintaining fibers (PMFs) combined to each other in respective centers thereof, provides two input ports, 113a and 113v and one output ports, 113c. The input ports, 113a and 113b, are respective ends of the PMFs, when the formed input 113a receives the test beam L_{S1} while the latter input 113b receives the other test beam L_{S2}. Two test beams, L_{S1} and L_{S2}, advance within the respective PMFs to the centers as maintaining the polarizations thereof and combined thereat. The combined test beam L_{S3}, which has two polarizations each reflecting the respective polarizations of the test beams, L_{S1} and L_{S2}, is output from the output port 113c. FIG. 9 concentrates a case where the former test beam L_{S1} has the polarization parallel to the slow axis of the PMF, while, the latter test beam L_{S2} has the polarization parallel to the fast axis.

Referring back to FIG. 7A, the output of the PBC 113 enters an optical connector 116 passing the optical coupler 114. The optical connector 116 is optically connected to one of connectors, 117 and 118, where the former connector 117 optically couples with the dummy port 123a, while, the latter connector 118 is connected to a power meter 119. The optical coupler 114 also couples with another power meter 115, or the setup shown in FIGS. 7A and 7B may switch one power meter for those power meters, 115 and 119. The other test port 123b also prepares the setup same with that described above.

The combined test beam L_{S4} reaches the optical connector 116 passing the optical coupler 114. The optical connector 116 may optically couple with one of the connectors, 117 and 118. The connector 117 couples with the dummy port 123a, while, the other connector couples with the power meter 119. Also, the optical coupler 114 also couples with the other power meter 115. FIGS. 7A and 7B show the setup having two power meters independent to each other. However, the setup may provide only one power meter selectively coupled with the optical coupler 114 and the optical connector 118. Also, the setup shown in FIG. 7A is applicable to the other dummy port 123b.

First, engaging the optical connector 116 with the optical connector 118, the output power of the optical sources, 112a and 112b, are set at a designed level as monitoring the power of the test beam L_{S4} by the power meter 119 and adjusting the bias sources, 111a and 111b, based on the monitored levels. Replacing the housing 2 with the reference block 104 and switching the engagement of the optical connector 116 with the optical connector 118 to the other optical connector 117, the dummy ports, 123a and 123b, may be aligned in the optical axes thereof with the housing 2. Specifically, the dummy ports, 123a and 123b, are disposed so as to face the reference surface 104a of the reference block 104. The test beam L_{S4}, which is generated by the optical sources, 112a and 112b, are output from the dummy ports, 123a and 123b, and reflected by the reference surface 104a, then return to the dummy ports, 123a and 123b. The power meter 115 may detect the power of the reflected test beam L_{S4} through the optical coupler 114. The dummy ports, 123a and 123b, are positioned or aligned with respect to the reference block 104 such that the power thus detected by the power meter 115 becomes a maximum; that is, the dummy ports, 123a and 123b, in the optical axes thereof are aligned with the reference block 104.

After the alignment of the dummy ports, 123a and 123b, the process replaces the reference block 104 with the housing 2 as shown in FIG. 3B, and further aligns the dummy ports, 123a and 123b, with respect to the housing 2. Then, the process carries out the alignment of the dummy ports, 123a and 123b. First, the one of the MMI devices 40 directly detects the test beam coming from the dummy port 123a by the PD built therein as sliding the dummy port 123a on the front wall 2A of the housing 2. Also, another MMI device 50 detects the test beam L_{S4} coming from the dummy port 123b by the built-in PD as sliding the dummy port 123b on the front wall 2A of the housing 2. The test beam has a field diameter of, for instance, 300 μm; while, the MMI devices, 40 and 50, provide the input ports with dimensions of several micron-meters in a width and about one micron-meter in a height; accordingly, the signals output from the built-in PDs become faint but substantial for determining respective positions of the dummy ports, 123a and 123b, at which the test beams detected by the built-in PDs become respective maxima. Thus, the positions of the dummy ports, 123a and 123b, perpendicular to respective optical axes may be determined. As for the alignment of the dummy ports, 123a and 123b, along the optical axes thereof may be automatically determined by abutting or attaching the dummy ports, 123a and 123b, against the front wall 2A of the housing 2.

Next, optical components involved in the second group, which need a precise alignment, are placed on respective optical paths between the MMI devices, 40 and 50, and the dummy ports, 123a and 123b, as detecting the test beams processed by the optical components by the built-in PD. The process does not restrict the order of the installation of the optical components described below. The order may be optional.

In the process for determining the positions of the dummy ports, 123a and 123b, the setup shown in FIG. 7B connects the VOA bias source 120 and the monitors, 121 and 122, to the housing 2. The VOA bias source 120 provides biases to the VOA 23, while, the monitors, 121 and 122, may monitor the outputs of the ICs, 43 and 53, on the circuit boards, 46 and 56.

After the determination of the dummy ports, 123a and 123b, the alignment process starts the practical alignment of respective optical components, that is, the BS 32 shown in FIGS. 1 and 2, is first aligned. The rotation angle of the BS 32 is aligned so as to maximize the reflection of the test beam L, which is provided from the auto-collimator 125 and passing the space above the housing 2, at the front facet of the BS 32; then, the BS 32 is placed on the VOA carrier 30 as keeping the rotational angle thus adjusted. Moving the BS 32 on the VOA carrier 30 along the optical axis, the process determines the position of the BS 32 on the VOA carrier 30 at which the magnitude of the split beam detected by the mPD 33 becomes a maximum. Then, the BS 32 is permanently fixed thereto by curing the resin applied between the BS 32 and the VOA carrier 30.

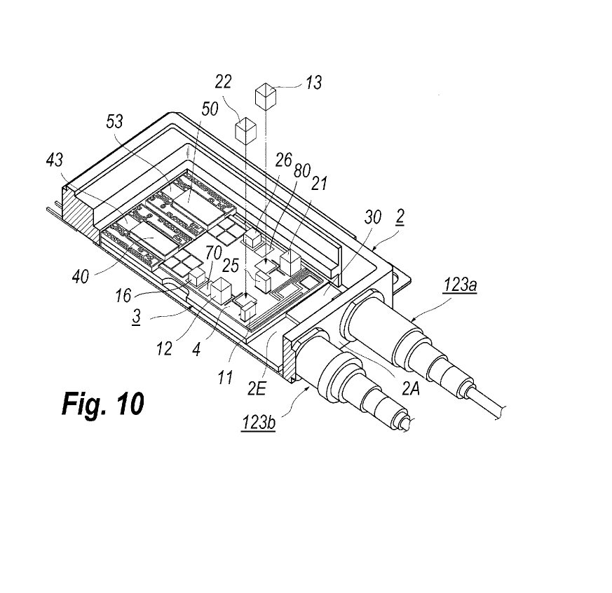

Next, as FIG. 10 illustrates, the process places the first reflector 13 and the second reflector 22 on the carrier 4. The reflectors, 13 and 22, are adjusted in respective rotations thereof such that the test beam L, which comes from the auto-collimator 125 and passes the space above the housing 2 is reflected at the front facets and detected by the auto-collimator 125, in the magnitude thereof becomes a maximum. Then, keeping the rotational angles, the reflectors, 13 and 22, are placed on the carrier 4. Then, irradiating the reflectors, 13 and 22, by the test beams L_{S4} coming from the test ports, 125a and 125b, the process determines the rotational angles of the reflectors, 13 and 22, such that the test beams L_{S3} reflected by the reflectors, 13 and 22, and detected by the built-in PDs of the MMI devices, 40 and 50, become respective maxima. Note that, in the alignment of the reflectors, 13 and 22, the rotational angles thereof determined through the auto-collimator 125 become substantial and are maintained through the alignment processes performed subsequent hereafter. Because the MMI devices, 40 and 50, in the rotation thereof against the housing 2 and the optical axes of the coupling units, 5 and 6, are determined in advance to the alignment of the reflectors, 13 and 22, the change of the rotation angle of the reflectors, 13 and 22, resultantly upsets the alignment of the MMI devices, 40 and 50, and the coupling units, 5 and 6. After the determination of the angles, the reflector, 13 and 22, are permanently fixed on the carrier by curing the resin applied thereto.

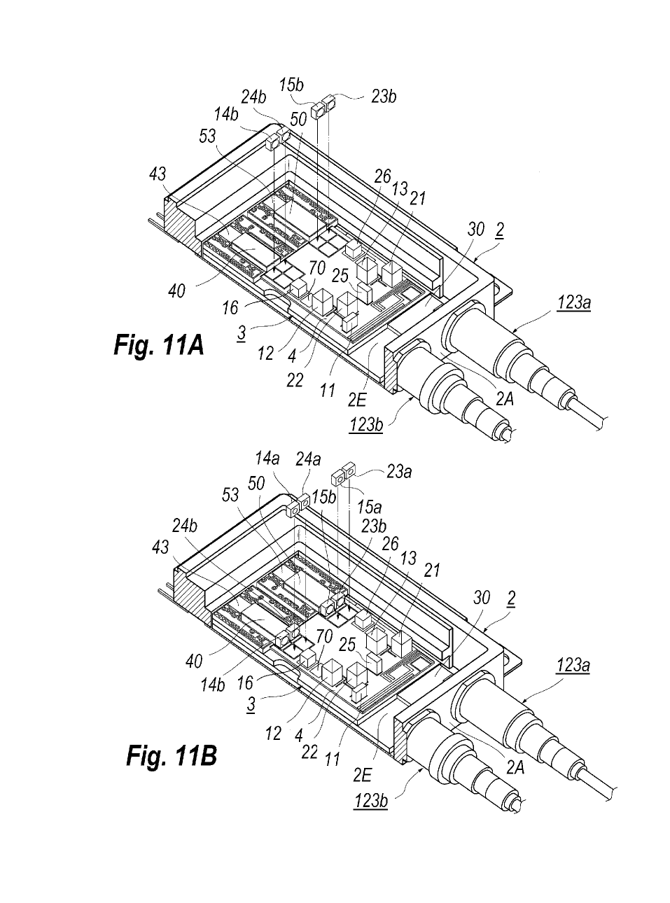

Next, the process determines the positions of the lens systems, 14, 15, 23, and 24, each including first and second lenses. The process first positions the first lenses, 14b, 15b, 23b, and 24b, namely, those placed closer to the MMI devices, 40 and 50, as FIG. 11A illustrates. Setting those first lenses, 14b to 24b on the carrier 4 as detecting the test beams that pass the first lenses, 14b to 24b, and concentrate onto the MMI devices, 40 and 50, by the built-in PDs, the first lenses, 14b to 24b, may be set in respective positions, namely, lateral replacements and a rotational angles thereof, at which the outputs of the built-in PDs become maxima. The first lenses, 14b to 24b, are permanently fixed thereto on the carrier 4 by curing the adhesive resin. Then, as FIG. 11B illustrates, the process determines the positions of the second lenses, 14a to 24a, placed apart from the MMI devices, 40 and 50, compared with the first lenses, 14b to 24b. The procedures to determine the positions and the rotational angles of the second lenses, 14a to 24a, are similar to those performed for the first lenses, 14b to 24b.

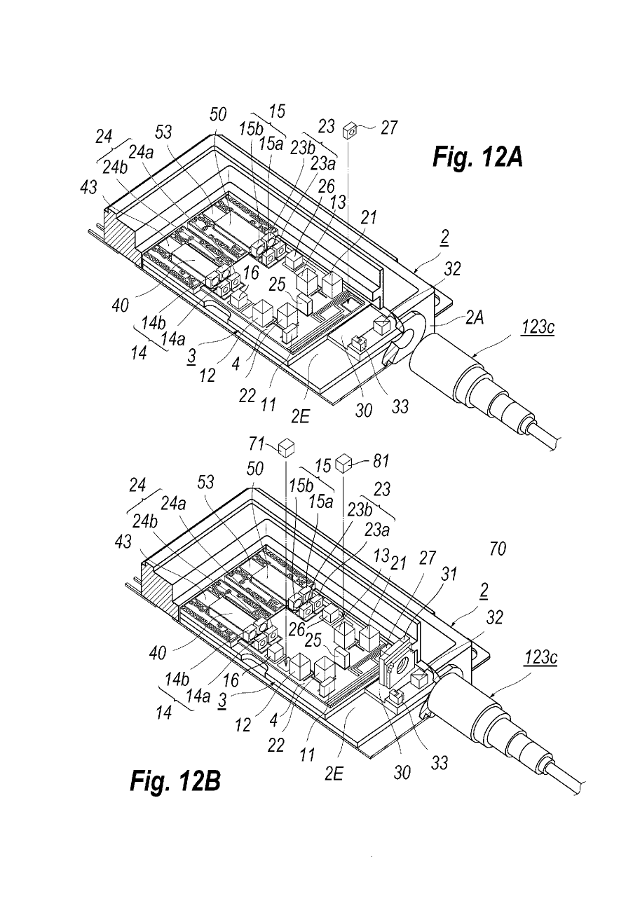

After the installation of four lens systems, 14 to 24, the process sets the input lens 27 as FIG. 12A indicates. As already explains, the coupling unit 6 for the signal beam built-in the concentrating lens whose focal point in the side of the inside of the housing 2 substantially coincides with the focal point of the input lens 27 in the side of the coupling unit 6. Accordingly, the procedure first replaces the dummy port 123a with another dummy port 123c that built-in a concentrating lens emulating the concentrating lens in the coupling unit 6. Because the concentrating lens in the coupling unit 6 concentrates the signal light provided from the SMF 36, and the VOA 31 in the aperture thereof is set substantially at the focal point of the concentrating lens, the VOA 31 may provide a narrowed aperture, which may make the VOA 31 compact, and show an enhanced extinction ratio of the beam passing therethrough. Accordingly, the optical alignment of the input lens 27 preferably uses the dummy port 123c that includes the concentrating lens fully emulating the concentrating lens built-in the coupling unit 6.

Specifically, the process sets the reference mirror 104 on the alignment stage 103 again substituting from the housing 2, and switching the connector 116 from the dummy port 123b to the dummy port 123c. Using the manipulator 90 shown in FIG. 6, the dummy port 123c is positioned at a point to which the coupling unit 6 is to be placed, at which the dummy port 123c faces the reference surface 104a of the reference block 104. Then, the process determines an attitude, namely, a rotation and a tilt angle against the reference surface 104a, such that the test beam L_{S4} output from the dummy port 123c, reflected by the reference surface 104a, and detected by the power meter 115 becomes a maximum. Thus, the dummy port 123c may be aligned with respect to the reference block 104. Then, the procedure replaces the reference block 104 with the housing 2 again, and aligns the dummy port 123c against the housing 2 within the plane perpendicular to the optical axis such that, as sliding the dummy port 123c on the front wall 2A of the housing 2, the test beam output from the dummy port 123c and detected through the built-in PD of the MMI device 50 becomes a maximum.

Then, the procedure moves the input lens 27 on the carrier 4 and aligns the input lens 27 by detecting the test beam L_{S4} output from the dummy port 123c, passing through the input lens 27, and detected by the built-in PD of the MMI device 50. Finally, the input lens 27 is fixed by adhesive resin at a position where the output of the built-in PD of the MMI device 50 becomes a maximum.

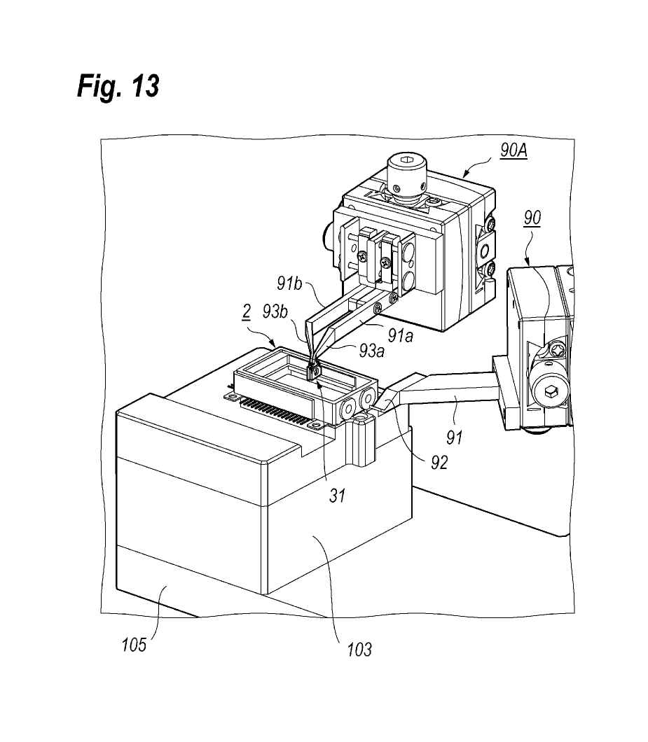

Then, as FIG. 12B and FIG. 13 illustrate, the process mounts the VOA 31 on the VOA carrier 30. A special manipulator 90A is used. The manipulator 90A provides two arms, 91a and 91b, that adjust the translational positions, X, Y, and Z, and two tilt angles, y and tp, against the optical axis thereof and test heads, 93a and 93b, in respective ends of the arms, 91a and 9 lb. The VOA 31 is put between the test heads, 93a and 93b. The test heads, 93 and 93b, which are electrically isolated from each other, are connected to the electrodes of the VOA 31 and supplied with biases from the bias source 120 indicated in FIG. 7B.

Applying ultraviolet curable resin on the VOA carrier 30 with a thickness of about 100 μm or more, and holding the VOA 31 apart from the VOA carrier 30 by a distance of about 100 μm, and supplying the bias altering between 0 and 5 V by a period of, for instance, one (1) seconds through the manipulator 90A; the VOA 31 is slid parallel to the bottom 2E of the housing 2 along the optical axis of the test beam L_{S4}, and The built-in PDs of the MMI devices, 40 and 50, detect the test beam L_{S4}. The VOA 31 may be set in a position at where the built-in PDs generate altering signals with amplitudes thereof within a designed range. Because the MMI devices, 40 and 50, in particular, the built-in PDs may concurrently detect the test beams L_{S4}, one of which passes the PBS 21, while, the other is reflected thereby; a difference between the outputs of the MMI devices, 40 and 50, may be regarded as a difference in attenuation of the two test beams L_{S4}. In a case where two test beams, L_{S1} and L_{S2}, are independently measured; it is hard to maintain the orthogonality of the polarizations thereof. In the present embodiment, because the PBC 113 receives the two test beams, L_{S1} and L_{S2}, after the orthogonality in the polarizations thereof are precisely aligned, a deviation of the orthogonality in the polarization appearing in the test beam L_{S4} may be effectively suppressed. Also, the VOA 31 is placed on the VOA carrier 30 as the optical axis thereof makes a substantial angle, for instance, around 7°, with respect to the axis connecting the input lens 28 with the concentrating lens in the dummy port 123c.

Then, as FIG. 12B illustrates, the process mounts the attenuators, 71 and 81, on the carrier 4. Similar to the process for the optical components in the first group like the BS 12 and the PBS 21, the process firs determines the angles of the attenuators, 71 and 81, using the test beam L coming from the auto-collimator 125; then, as maintaining the angles thereof, the attenuators, 71 and 81, are placed at the designed positions, 70 and 80, on the carrier 4. Hardening the resin, the attenuators, 71 and 81, are permanently fixed to the carrier 4.

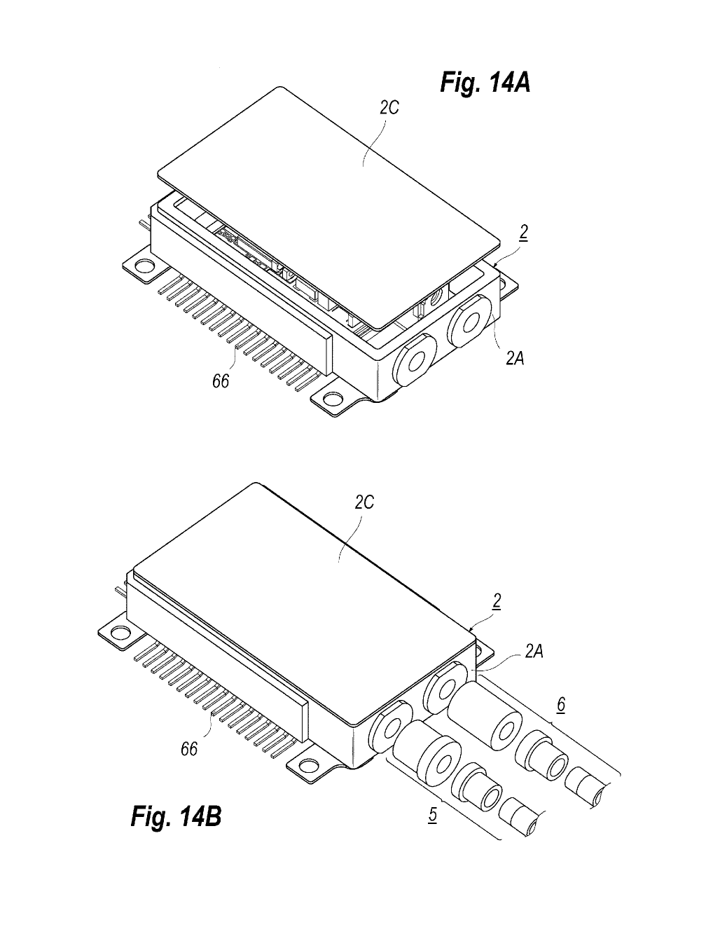

Finally, as FIG. 14A and 14B illustrate, a lid 2c air-tightly seals the housing 2, and the dummy ports, 123a and 123b, are replaced with the signal coupling unit 6 and the local coupling unit 5. Specifically, supplying a test beam from the signal coupling unit 6, and detecting the test beam by the built-in PD of the MMI device 40, the signal coupling unit 6 is positioned at a point on the front wall 2A of the housing 2 where the output of the built-in PD of the MMI device 40 becomes a maximum. Similarly, the local coupling unit 5 may be positioned at a point on the front wall 2A where the output of the built-in PD of the MMI device 50 becomes a maximum. After the determination of the positions, the signal coupling unit 6 and the local coupling unit 5 are permanently fixed to the front wall 2A of the housing 2 by, for instance, the laser welding.

### Second Embodiment

Next, a method of testing the optical coherent receiver 1 according to the second embodiment of the invention will be described.

The test procedures using the setup 500 will be described. First, two optical sources, 112a and 112b, which generate two test beams, L_{S1} and L_{S2}, with polarizations orthogonal to each other, are prepared. These two test beams, L_{S1} and L_{S2}, enter the PBC 113, and the PBC 113 may generate a test beam L_{S4} with two polarizations that emulates the signal beam Sig for the optical coherent receiver 1. On the other hand, the third source 112c generates the third beam L_{S4} that has a wavelength different from those of the first and second test beams, L_{S1} and L_{S2}. In an example, the first and second test beams, L_{S1} and L_{S2}, have the wavelength of 1550.116 nm (193.4 THz), while, the third test beam L_{S3} has the wavelength of 1550.108 nm (193.401 THz), which is different by 1 GHz; accordingly, the MMI devices in the optical coherent receiver 1 may cause a beat of 1 GHz. Because the MMI devices in the coherent receiver 1 are necessary to generate electrical signals with relatively small magnitude, the monitor device 140 such as an oscilloscope may sense the outputs of the optical coherent receiver in frequency components synchronizing with the beat frequency. The first and second test beams, L_{S1} and L_{S2}, are set to have magnitudes thereof substantially same with each other; and those test beams, L_{S1} to L_{S3}, are, what is called, a continuous wave (CW). The optical coherent receiver 1, as described above, interferes two test beams, L_{S3} and L_{S4}, and may generate four electrical signals, V₁ to V₄, each having the differential arrangement, and able to be monitored in the time behaviors thereof by the oscilloscope 140.

The optical coherent receiver 1 may be evaluated in, for instance in the outputs of the ICs, 43 and 53, as monitoring the outputs thereof by the oscilloscope 140. Utilizing the built-in PDs integrated with the MMI devices, 40 and 50, two test beams, L_{S1} and L_{S2}, having the polarizations orthogonal to each other may be concurrently detected, which means that the sensitivity of the built-in PDs may be concurrently determined.

An advantage of the setup 500 for evaluating the optical coherent receiver 1 will be described. The setup 500 provides two test beams, L_{S1} and L_{S2}, having polarization orthogonal to each other, and the PBC 113 that provides these test beams, L_{S1} and L_{S2}, in the optical coherent receiver 1 by merging them into the only one test beam L_{S4}. The optical coherent receiver 1, which provides the PBS 21 for the signal beam, may suppress the variation of the magnitude of the beams depending on the rotation of the polarizations. Specifically, when the merged beam L_{S4} rotates the polarization angle around the optical axis thereof, that is, the relative angle of the polarizations with respect to the crystal axis of the PBS 21 rotates; the magnitude of one polarization of the first beam L_{S1} increases and that of another polarization orthogonal to the former polarization decreases, however, the one polarization of the second beam L_{S2} decreases and the other polarization of the second beam L_{S2} increases. Accordingly, two beams output from the PBS 21 and containing two test beams, L_{S1} and L_{S2}, may maintain the total magnitudes thereof in substantially constant. That is, the test beam L_{S4} in the polarizations thereof becomes substantially independent of the axis of the PBS 21.

In a conventional setup where only one optical source is prepared for emulating the signal beam Sig, and the setup is necessary rotate the polarization of the test beam sequentially, the polarization of the test beam with respect to the axis of the PBS 21 is inevitable to be precisely adjusted; that is, a two-step measurement conventionally carried out requests a preciseness in the angle between the polarizations and against the axis of the PBS 21. Conventionally, the first step measures the XI and XQ components for the X-polarizations that is, for instance, precisely parallel to the bottom 2E of the housing 2, and the second step, which is done after the precise rotation of the polarization of the test beam, performs the measurement of the YI and YQ components for the Y-polarization which is perpendicular to the bottom 2E of the housing 2. The measurement or the evaluation according to the present embodiment may obtain the respective magnitudes through only one measurement.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A method of assembling an optical coherent receiver that receives a signal beam having two polarizations substantially orthogonal to each other and a local beam having a substantially linear polarization, the optical coherent receiver including a polarization beam splitter (PBS) that splits the signal beam into two portions depending on the polarizations thereof, a beam splitter (BS) that splits the local beam into two portions independent of the linear polarization of the local beam, and two multi-mode interference (MMI) devices, the method comprising steps of:
preparing a test beam by combining a first test beam having a substantially linear polarization and a second test beam having a substantially linear polarization whose direction is orthogonal to the polarization of the first test beam, the test beam emulating the signal beam;
preparing a third test beam having a substantially linear polarization, the third test beam emulating the local beam;
entering the test beam and the third test beam into the coherent receiver from respective dummy ports;
coupling the test beam and the third test beam concurrently with the two MMI devices.

2. The method of claim 1,
wherein the step of coupling the test beam and the third test beam with the two MMI devices includes steps of:
splitting the test beam into two portions by the PBS, and the third test beam into two portions by the BS, and
coupling one of the two portions of the test beam and one of the two portions of the third test beam with one of the two MMI devices, and concurrently coupling another of the two portions of the test beam and another of the two portions of the third test beam with another of the two MMI devices,
wherein the one of the two MMI devices interferes the one of the two portions of the test beam with the one of the two portions of the third test beam, and the another of the two MMI devices concurrently interferes the another of the two portions of the test beam with the another of the two portions of the third test beam.

3. The method of claim 2,
further including a step of, before preparing the test beam and the third test beam,
preparing an alignment beam by an auto-collimator, the alignment beam passing a space above the optical coherent receiver and being perpendicular to a front wall of a housing of the optical coherent receiver, the dummy ports being to be attached to the front wall of the optical coherent receiver.

4. The method of claim 3,
further including a step of, before the step of entering the test beam and the third test beam into the coherent receiver but before the step of aligning the PBS and the BS,
positioning the PBS and the BS at the space above the optical coherent receiver such that the PBS and the BS in beam incident surfaces thereof make an angle perpendicular to the alignment beam coming from the auto-collimator.

5. The method of claim 2,
wherein the optical coherent receiver further includes lens systems each concentrating the two portions of the test beam split by the PBS and the two portions of the third test beam split by the BS onto the MMI devices,
wherein the method further including steps of, after the step of coupling the test beam and the third test beam with the two MMI devices,
aligning the lens systems for the two portions of the test beam split by the PBS with the MMI devices using the test beam, and
aligning the lens systems for the two portion of the third test beam split by the BS the MMI devices using the another test beam.

6. The method of claim 1,
wherein the first test beam and the second test beam have wavelengths different from a wavelength of the third test beam

7. The method of claim 3,
wherein the wavelength of the first test beam and the wavelength of the second test beam are substantially equal to each other but different from the wavelength of the third test beam by above 1 GHz.

8. The method of claim 1,
wherein the step of preparing the test beam includes steps of,
splitting an original test beam having a substantially linear polarization into two beams,
passing one of the original test beam split at the antecedent step through a half-wavelength (λ/2) so as to generate the first test beam and another of the original test beam through an optical delay element that generates a delay substantially equal to a delay caused by the one of the two beams passing the λ/2 plate so as to the second test beam, and
combining the first test beams with the second test beam to generate the test beam.

9. A method of testing an optical coherent receiver capable of extracting data from a signal beam with a dual polarization, the method comprising steps of:
generating a first test beam by a first optical source, a second test beam by a second optical source, and a third test beam by a third optical source,
adjusting the first test beam and the second test beam such that polarizations thereof become orthogonal to each other;
combining the first test beam with the second test beam to generate a combined test beam after adjusting the polarizations thereof; and
entering the combined test beam into the optical coherent receiver from one port and the third test beam into the optical coherent receiver from another port.

10. The method of claim 9,
wherein the optical coherent receiver includes two multi-mode interference (MMI) devices, and
wherein the method further including steps of, after the step of entering the combined test beam and the third test beam into the optical coherent receiver,
splitting the combined test beam into two beams depending on the polarizations thereof and the third test beam into two beams, one of the MMI devices outputting an electrical signal by interfering one the beams split from the test beam with one of the beams split from the third test beam, another of the MMI devices outputting another electrical signal by interfering another of the beams split from the test beam with another of the beams split from the third test beam, and
monitoring the electrical signal and the another electrical signal output from the MMI devices concurrently.

11. The method of claim 9,
further including
wherein the first test beam and the second test beam have wavelengths different from a wavelength of the third test beam.

12. The method of claim 11,
wherein the wavelength of the first test beam and the wavelength of the second test beam are substantially equal to each other but different from the wavelength of the third test beam by about 1 GHz.

13. The method of claim 10,
wherein the step of generating the first test beam and the second test beam includes steps of,
splitting the first test beam into two beams, passing one of the two beams through a half-wavelength (λ/2) and another of the two beams through an optical delay element that generates a delay substantially equal to a delay caused by the one of the two beams passing the λ/2 plate, and
combining the one of the two beams passing the λ/2 plate with the another of the two beams passing the optical delay element.
